(19) United States
(12) Patent Application Publication
(10) Pub. No.: US 2020/0391373 A1
(43) Pub. Date: Dec. 17, 2020

(54) FRAME FOR MOUNTING AND CONTROLLING ROBOT ASSISTED MANUFACTURING

(71) Applicant: Red Rabbit Automation, Niles, MI (US)

(72) Inventors: John Cammarata, Berrien Springs, MI (US); Robert Kracker, Baroda, MI (US)

(73) Assignee: Red Rabbit Automation, Niles, MI (US)

(21) Appl. No.: 16/440,070

(22) Filed: Jun. 13, 2019

(51) Int. Cl. B25J 9/00

(52) U.S. Cl. CPC B25J 9/0009

(57) ABSTRACT

A frame for mounting and controlling robot assisted manufacturing is disclosed. The frame may comprise at least two crossmembers fastened or attached to the frame through a plurality of holes at base of the frame. The frame may have a polyhedron structure and the at least two crossmembers may traverse through at least two sides of the base. A control box may be mounted on top of the frame for controlling an equipment performing the robot assisted manufacturing. A plurality of cables may be routed from the control box through the frame towards the equipment. The equipment may be held in an inverted position through assorted hole patterns.

### FIELD OF THE DISCLOSURE

The disclosure relates to a frame for mounting and controlling robot assisted manufacturing. More specifically, the disclosure relates to an improved frame structure that is modular, redeployable, expedites construction, implementation, and reduces manufacturing cell area and waste.

### BACKGROUND OF THE DISCLOSURE

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Robotic process automation (RPA) is an automation process involving control of physical processes through robots. The robots of RPA have their respective workstations just like human workers. RPA has evolved over the years and laid foundation for the automation process to implement artificial intelligence (AI). The introduction of AI allows the robots to perform more intelligently compared to use of static rules in RPA. The implementation of RPA however requires a frame structure far—holding the robots.

Existing technologies involve fixing of automation tools or robots permanently in a position to manufacture a product. The robots cannot be moved without disrupting the production or utility of the RPA. There is large amount of value in being able to redeploy equipment without losing the cost associated with reintegrating the industrial robots, rewiring every connection, and repositioning each component in a cell.

Few robot sellers and resellers have provided solutions by way of collaborative and industrial robots on rolling carts. These robots typically have a weight capacity at or below 10 kg. The carts are typically on casters and frames made of bolted together aluminum extrusion. The reach; carrying capacity, and durability of these systems are all highly limiting, particularly for high precision manufacturing. The instability of the lightweight carts caused by its diminutive size, aluminum structure, and bolted joints makes the industrial robots unreliable with repeatability of placement of manufactured components.

It is therefore essential to develop a modular, redeployable frame structure that expedites construction, implementation and redeployment, reduces manufacturing cell area, and reduces waste.

### BRIEF DESCRIPTION OF THE EXEMPLARY EMBODIMENTS

According to an aspect, present embodiments may be associated with a frame for mounting and controlling robot assisted manufacturing. The frame may comprise at least one crossmember. In one embodiment, the frame may comprise at least two crossmembers bolted to the frame through a plurality of holes at base of the frame. Though mentioned as “bolted” it is contemplated that crossmembers are detachably attached to the frame. The detachable attachments may be bolts or other fasteners. The frame may be a polyhedron structure and the at least two crossmember may traverse through at least two sides of the base. A control box may be mounted on top of the frame for controlling an equipment performing the robot assisted manufacturing. A plurality of cables may route from the control box through the frame towards the equipment.

In an embodiment, the frame may comprise an upper half and a lower half, and the upper half and the lower half may be joined at four flanges with thirty-two bolts. The frame may be about 72×114×122.25 inches in dimensions. The frame may be made up of 6×6 A36 steel tubing with a wall thickness of about 3/16″. The frame may have at least an entry and an exit side of the base. The at least one entry and exit side may be on the same side or different sides and may further include a plurality of sides on the same or different sides. The at least two crossmembers may comprise hole patterns to interface with the equipment. The equipment may be utilized for a manufacturing function selected from at least one of loading machines, unloading machines, handling, assembling, gauging, deburring, painting, polishing, and grinding assemblies or individual parts or components. The equipment may be held in inverted position through assorted hole patterns.

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a top view of a frame [100], according to an embodiment;

FIG. 2 illustrates a first side view of the frame [100], according to an embodiment;

FIG. 3 illustrates a second side view of the frame [100], according to an embodiment;

FIG. 4 illustrates a perspective view of the frame [100], according to an embodiment; and

FIG. 5 illustrates an equipment [500] in operation, according to an embodiment.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

The headings used herein are for organizational purposes only and are not meant to limit the scope of the description or the claims. To facilitate understanding, reference numerals have been used, where possible, to designate like elements common to the figures.

### DETAILED DESCRIPTION

The following Detailed Description refers to accompanying drawings to illustrate exemplary embodiments consistent with the present disclosure. References in the Detailed Description to “one exemplary embodiment,” an “exemplary embodiment,” an “example exemplary embodiment,” etc., indicate the exemplary embodiment described may include a particular feathre, structure, or characteristic, but every exemplary embodiment may not necessarily include the particular feature, structure, or characteristic. Moreover, such phrases are not necessarily referring to the same exemplary embodiment. Further, when a particular feature, structure, or characteristic may be described in connection with an exemplary embodiment, it is within the knowledge of those skilled in the art(s) to effect such feature, structure, or characteristic in connection with. other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to limit the present disclosure. Rather, the scope of the present disclosure is defined .only in accordance with the following claims and their equivalents.

Reference will now be made in detail to various embodiments. Each example is provided by way of explanation and is not meant as a limitation and does not constitute a definition of all possible embodiments.

Redeployable Robot Unit (“RRU”) is a frame structure with assorted hole patterns to quickly and easily attach an industrial robot in an inverted orientation and auxiliary equipment for the presentation and processing of material through manufacturing processes.

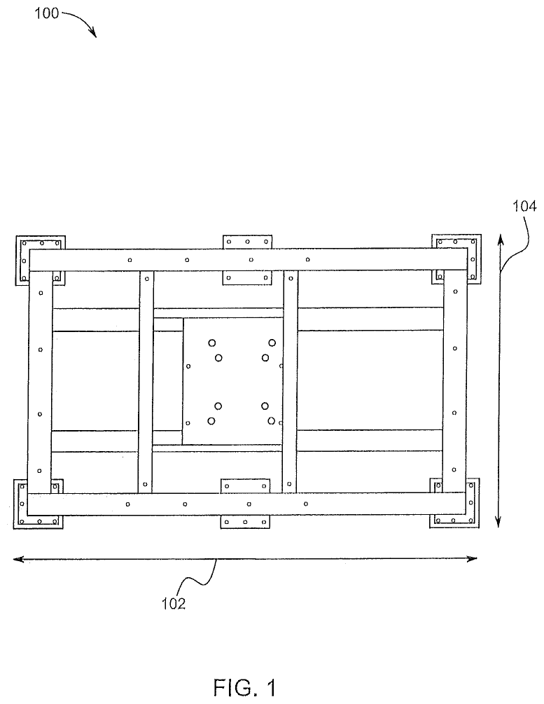

FIG. 1 illustrates a top view of a frame [100], according to an embodiment. The frame [100] has a length [102] and breadth [104] as illustrated in FIG. 1. The length [102] and the breadth [104] maybe 114 inches and 72 inches respectively. The frame [100] may be made up of 6×6 A36 steel tubing with a wall thickness of about 3/16″. The lengths and breadths described are exemplary.

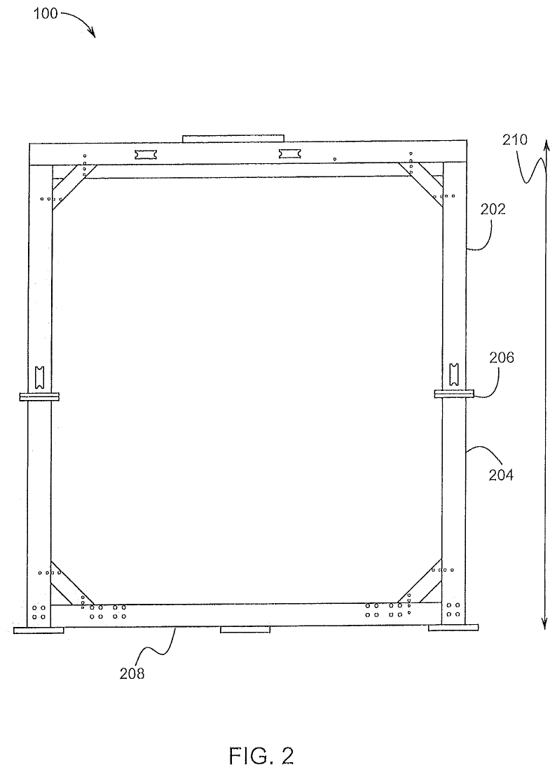

FIG. 2 illustrates a first side view of the frame [100], according to an embodiment. The frame [100] may comprise an upper half [202] and a lower half [204]. The upper half [202] and the lower half [204] may be joined at four flanges with thirty-two bolts. The first side view of the frame [100] illustrates the upper half [202] and the lower half [204] joined at section [206]. In an embodiment, the frame [100] may comprise at least two crossmembers bolted to the frame [100] through a plurality of holes at base of the frame. As illustrated in FIG. 2, a first crossmember [208] is bolted to a first side of the base. Whilst first crossmember [208] is shown on the lower half [204], it may be equally be connecting on the upper half [202]. The frame [100] may have a height [210] of about 122.25 inches. Such height is only exemplary.

The frame [100] may be a polyhedron structure and the at least two crossmembers may traverse through at least two sides of the base. In an embodiment, the frame has at least one of a rectangular prism shape, a triangular prism shape, a pentagonal prism shape, an N-gon prism shape, and a cylindrical shape. The frame may be made as a single weldment or multiple weldments joined with fasteners or by other means.

Conventionally, the make and model of an industrial robot determines the size and strength of a specific frame, however the concept of the frame or the RRU is independent of the industrial robot affixed to it.

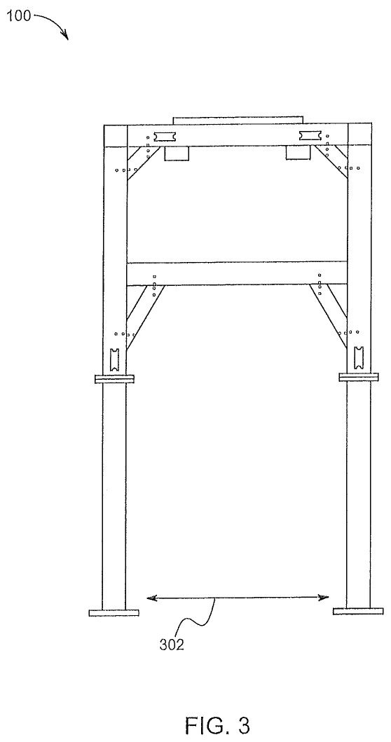

FIG. 3 illustrates a second side view of the frame [100], according to an embodiment. The frame may have at least an entry and an exit side of the base. The entry and the exit side of the base is an opening [302] to receive machines, articles, products and the like to be operated by an equipment. The frame or the RRU may be used to load and unload machines, handle, assemble, machine, gauge, deburr, paint, polish, and grind components or assemblies, including other manufacturing processes such as hammer peening and shot peening processes. The frame may be modular, allowing pieces to be quickly added, arranged, and rearranged to fit each application without designing custom interfaces or orientations. Standard hole patterns to fit multiple industrial robots as well as a standard drawer system and conveyor in multiple configurations may allow for flexibility of implementation without increasing time of design or build.

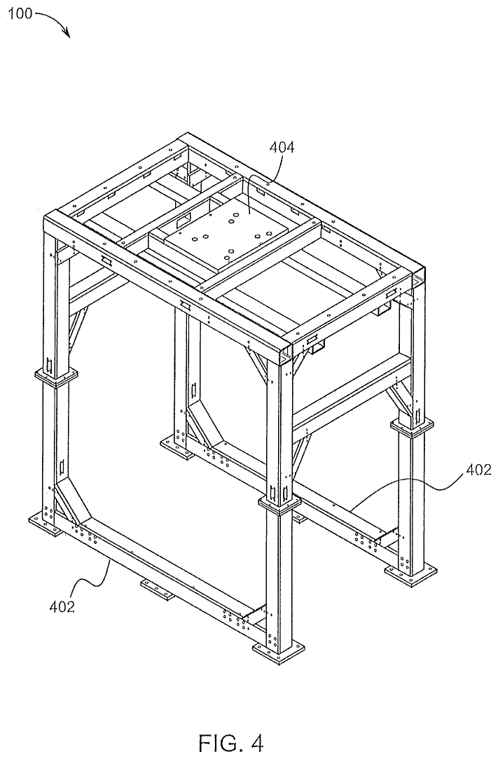

FIG. 4 illustrates a perspective view of the frame [100], according to an embodiment. The frame [100] for mounting and controlling robot assisted manufacturing is disclosed. The frame

may comprise at least two crossmembers [402] bolted through a plurality of holes at base of the frame. The frame [100] may be a polyhedron structure and the at least two crossmembers [402] traverse through at least two sides of the base. A control box (not shown) may be mounted on top [404] of the frame [100] for controlling an equipment performing the robot assisted manufacturing. A plurality of cables (not shown) may route from the control box through the frame [100] towards the equipment. The at least two crossmembers [402] may comprise hole patterns to interface with the equipment.

In an embodiment, crossmembers are bolted to the frame using one of the six sets of holes. The crossmembers contain hole patterns that interface with equipment like drawer systems, conveyors, and weldments specific to an application. As mentioned earlier, the crossmembers may be detachably attached to the frame using fasteners other than bolts. Cables are routed through the frame from the control box on top of the unit to equipment around the midpoint or near the bottom of the, frame. This significantly reduces installation and redeployment time when compared to field wiring components to each other in custom cut wireways.

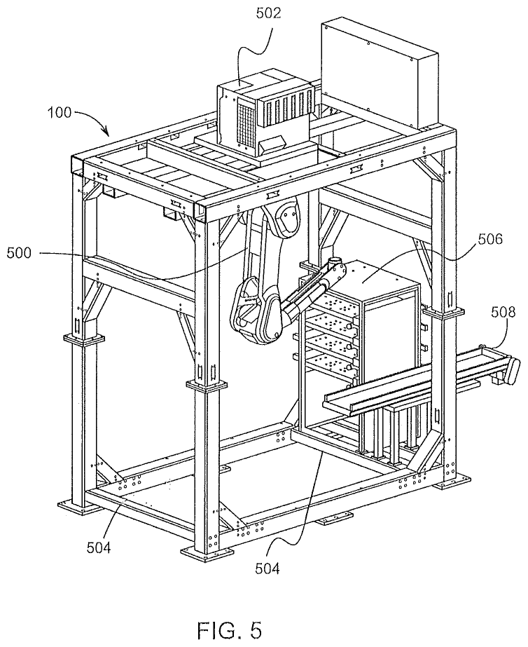

In an aspect, the equipment is held in inverted position through assorted hole patterns. FIG. 5 illustrates an equipment [500] in operation, according to an embodiment. The equipment is controlled by a control unit [502]. In an exemplary scenario, the equipment [500] or robot is a FANUC M-20iB/25. The robot is inverted in the frame [100] with its control unit [502] sitting directly above it. The control unit [502] sits on top of the frame [100] and can be placed along any side by the 4 bolt patterns, as illustrated. With lower crossmembers [504] across the two endmost hole patterns of the frame [100], their span matches that of the drawer system [506] and conveyor [508] that are optioned. Other common modules may include 2D vision system, 3D vision system, part gripping system, gauging system, and pallet-interface weldment. While lower crossmembers [504] are shown, any embodiment need not have any lower crossmembers [504] or may include at least one lower crossmember [504].

The RRU or frame [100] is rigid and robust, capable of supporting an industrial robot in an inverted position and auxiliary equipment surrounding it to aide in the automation of manufacturing processes. The rigidity of the welded tube steel design with gusseted corners ensure reliable part placement without frame [100] deflection compromising the accuracy of the attached industrial robot.

Suspending the robot from the top of the structure reduces floorspace required for the cell as equipment for part handling, entry, and exit can be placed directly under the robot. While robots have been mounted on planes outside of horizontal and up to 90 deg from horizontal, the inverted robot [500] on a movable platform, as illustrated in FIG. 5, is disclosed.

The modular frame [100] allows pieces to be quickly added, arranged, and rearranged to fit each application without designing custom interfaces or orientations. Standard hole patterns to fit multiple industrial robots as well as a standard drawer system and conveyor in multiple configurations allow for flexibility of implementation without increasing time of design or build.

The frame [100] is designed to be moved by a forklift. Attaching the equipment or robot to the frame [100] means all the pieces move as a unit, so reprogramming the robot to interface with the attached equipment is not required. Programming points outside of the RRU such as interfacing with machine tools is still required, but this is significantly faster than teaching every point again, as is the case with traditional automation, if it can be repurposed at all.

In an embodiment, the RRU [100] has been optimized to operate with the FANUC M-710/C/70 robot. The RRU [100] is constructed in 2 pieces, an upper and lower half that are joined at 4 flanges with 32 bolts. Total dimensions of the RRU [100] are 72×114×122.25 inches. The structure of RRU [100] is made of 6×6 A36 steel tubing with a wall thickness of 3/16″. 6 footpads with 24 anchor bolts attach the RRU [100] to the floor.

In the design as described above, finite element analysis was conducted to confirm the operation of the RRU [100] up to and beyond maximum load conditions. Structural rigidity of a frame is paramount to operation because positional accuracy during operation is critical. With 3500 lbs of load applied to the robot, affixing bolts accelerating under maximum braking, the displacement at the stop of the frame (base of the robot) was 0.052″ in the longitudinal direction and 0.048″ in the transverse direction of the frame. This rigidity of the frame [100] allows the robot [500] to maintain positional accuracy even with an outstretched reach of 2050 mm.

The overall dimensions (height, width, length) of the frame [100] can be maintained and structural integrity achieved with different materials if tube size and wall thickness were to change accordingly. Materials most similar may be one of steel alloys, aluminum alloys, titanium alloys, and other metals. In an embodiment, the equipment [500] is utilized for at least one of loading machines; unloading machines, handling, assembling, gauging, deburring, painting, polishing, and grinding assemblies. It is further contemplated that one or more frames may be placed adjacent to each other and each frame may be configured to be the same as or different from any frame in the configuration.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, there by including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specificationand claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable; or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

The terms “determine”, “calculate” and “compute,” and variations thereof, as used herein, are used interchangeably and include any type of methodology, process, mathematical operation or technique.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect. Thus, the following claims are hereby incorporated into this Detailed Description, with each claim standing on its own as a separate embodiment of the present disclosure.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A frame for mounting and controlling robot assisted manufacturing, the frame comprising:
at least two crossmembers fastened to the frame through a plurality of holes at base of the frame, wherein the frame is a polyhedron structure and the at least two crossmembers traverse through at least two sides of the base;
a control box mounted on top of the frame for controlling an equipment performing the robot assisted manufacturing; and
a plurality of cables routing from the control box through the frame towards the equipment.

2. The frame as claimed in claim 1, wherein the frame comprises an upper half and a lower half, and wherein the upper half and the lower half are joined at four flanges with thirty-two bolts.

3. The frame as claimed in claim 1, wherein dimensions of the frame are about 72×114×122.25 inches.

4. The frame as claimed in claim 1, wherein the frame is made up of 6×6 A36 steel tubing with a wall thickness of about 3/16″.

5. The frame as claimed in claim 1, wherein the frame has at least an entry and an exit side of the base.

6. The frame as claimed in claim 1, wherein the at least two crossmembers comprise hole patterns to interface with the equipment.

7. The frame as claimed in claim 1, wherein the equipment is utilized for at least one function selected from the group consisting of loading machines, unloading machines, handling, assembling, gauging, deburring, painting, polishing, peening, and grinding assemblies or individual components.

8. The frame as claimed in claim 1, wherein the equipment is held in inverted position through assorted hole patterns.
